(19) United States
(12) Patent Application Publication
(10) Pub. No.: US 2017/0114195 A1
(43) Pub. Date: Apr. 27, 2017

(54) Polymeric Film Comprising Copolyether-Ester Copolymer

(71) Applicant: Cryovac, Inc., Duncan, SC (US)

(72) Inventor: Solomon Bekele, Taylors, SC (US)

(21) Appl. No.: 14/919,969

(22) Filed: Oct. 22, 2015

(51) Int. Cl. C08J 5/18; B32B 27/36; A61J 1/14; B29C 47/06; B29C 65/00; A61J 1/10; B32B 27/06; B29C 47/00

(52) U.S. Cl. CPC C08J 5/18; B32B 27/06; B32B 27/36; B29C 47/0004; B29C 47/0021; B29C 47/061; B29C 65/002; A61J 1/10; A61J 1/1468; C08J 2367/02; B32B 2439/80; B29K 2033/04

(57) ABSTRACT

The presently disclosed subject matter is directed generally to monolayer or multilayer films suitable for use in forming pouches, such as (but not limited to) medical solution pouches. When used in the formation of solution pouches, the disclosed films help prevent or reduce the presence of bubbles in the solution after heat sterilization, such as autoclaving. In particular, the presently disclosed subject matter provides a polymeric film for forming pouches that are capable of passing the bubble test as set forth in the Chinese State Drug Package Container Material Standard No. YBB00112005. The disclosed film comprises at least one anti-foaming layer comprising copolyether-ester copolymer.

### CROSS REFERENCE TO RELATED APPLICATIONS

The subject application claims the benefit of U.S. Provisional Patent Application No. 60/066,956, filed Oct. 22, 2014, the entire content of which is hereby incorporated by reference.

### FIELD OF THE INVENTION

The presently disclosed subject matter generally relates to polymeric films suitable for use in a wide variety of applications. More particularly, the presently disclosed films are suitable for forming medical solution pouches with no/reduced amounts of bubbles in the packaged solution after heat sterilization. Medical solution pouches formed from the disclosed films are capable of passing the bubble test as set forth in the Chinese State Drug Package Container Material Standard No. YBB00112005.

### BACKGROUND

It is common practice to supply solutions for medical use in the form of disposable, flexible pouches. The pouches must meet a number of performance criteria, including collapsibility, optical clarity, transparency, high temperature heat resistance, and sufficient mechanical strength to withstand the rigors of the environment in which they are used. Medical solution pouches should also provide a sufficient barrier to the passage of moisture vapor and other gases to prevent contamination of the solution contained therein.

Heat sterilization of solution-containing medical pouches typically occurs in an autoclave at about 250° F. for periods of about 15 to 30 minutes. Commonly, heat sterilization results in the formation of bubbles within the solution packaged within the pouch, which is believed to result from film components that have migrated during the autoclave process. The presence of bubbles can in some cases be undesirable. For instance, films for use in Chinese medical pouches must pass a “bubble test” wherein any bubbles that form in the packaged solution after autoclaving and rigorous shaking must quickly dissipate.

It would be beneficial to provide a flexible film suitable for the manufacture of medical solution pouches. It would also be advantageous if solution pouches formed from the disclosed film had a reduced proficiency for forming bubbles in the packaged solution after heat sterilization.

### SUMMARY

In some embodiments, the presently disclosed subject matter is directed to a polymeric film comprising at least one antifoaming layer, wherein the antifoaming layer comprises about 10 to 100 weight percent copolyether-ester copolymer, based on the total weight of the layer, and about 0 to 90 weight percent polyamide, polyester, polyolefin, or combinations thereof, based on the total weight of the layer.

In some embodiments, the disclosed film can be used to form a pouch. Particularly, the pouch can include front and back sheets oriented in a face-to-face relationship and sealed to each other along adjacent side edges to define an interior compartment therebetween.

In some embodiments, the presently disclosed subject matter is directed to a method of reducing or preventing the formation of bubbles in a solution contained within a pouch after heat sterilization. Specifically, the method comprises extruding the disclosed film and forming the film into a pouch having an interior space for receiving a medical solution, wherein upon packaging a medical solution therein, the pouch is capable of passing the bubble test as set forth in the Chinese State Drug Package Container Material Standard No. YBB0112005.

### DETAILED DESCRIPTION

### I. General Considerations

The presently disclosed subject matter is directed generally to polymeric films suitable for use in forming pouches, such as (but not limited to) medical solution pouches. When used in the formation of solution pouches, the disclosed films help prevent or reduce the presence of bubbles in the packaged solution after heat sterilization, such as autoclaving. In particular, the disclosed films are useful in forming pouches that are capable of passing the bubble test as set forth in the Chinese State Drug Package Container Material Standard No. YBB00112005. The disclosed films comprise at least one anti-foaming layer comprising a copolyether ester copolymer, as set forth in more detail herein below.

### II. Definitions

Following long standing patent law convention, the terms “a”, “an”, and “the” refer to “one or more” when used in the subject application, including the claims. Thus, for example, reference to “a film” includes a plurality of such films, and so forth.

The term “adjacent” as used herein refers to the positioning of two film layers in contact with one another with or without an intervening layer (such as a tie layer), adhesive, or other layer therebetween.

As used herein, the terms “barrier” and “barrier layer” as applied to films and/or film layers, refer to the ability of a film or film layer to serve as a barrier to gases and/or odors. Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, co-polyamide, polyester, polyglycolic acid, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger. In some embodiments, metal foil, metallized substrates (e.g., metallized polyethylene terephthalate (PET), metallized polyamide, and/or metallized polypropylene), and/or coatings comprising SiOx or AlOx compounds can be used to provide low oxygen transmission to a package. In some embodiments, a barrier layer can have a gas (e.g., oxygen) permeability of less than or equal to about 2000 cc/m²/24 hrs/atm at 73° F., in some embodiments less than about 1500 cc/m²/24 hrs/atm at 73° F., in some embodiments less than about 1000 cc/m²/24 hrs/atm at 73° F., and in some embodiments less than about 500 cc/m²/24 hrs/atm at 73° F., in accordance with ASTM D-3985. The entire contents of all referenced ASTMs herein are incorporated by reference.

The term “bulk layer” as used herein refers to a layer used to increase the abuse-resistance, toughness, modulus, etc., of a film. In some embodiments, the bulk layer can comprise polyolefin (including but not limited to) at least one member selected from the group comprising ethylene/alpha-olefin copolymer, ethylene/alpha-olefin copolymer plastomer, low density polyethylene, and/or linear low density polyethylene and polyethylene vinyl acetate copolymers.

The term “directly adjacent” as used herein refers to adjacent film layers that are in contact with each other without any tie layer, adhesive, or other layer therebetween.

As used herein, the term “ethylene/alpha-olefin copolymer” refers to such heterogeneous materials as low density polyethylene (LDPE), linear medium density polyethylene (LMDPE), linear low density polyethylene (LLDPE), and very low and ultra low density polyethylene (VLDPE and ULDPE); as well as homogeneous polymers such as Dowlex SC2107 ethylene/alpha olefin copolymers supplied by Dow Ziegler/Natta catalyzed. These materials generally include copolymers of ethylene with one or more comonomers selected from C4 to C10 alpha-olefins such as butene (i.e., 1-butene), hexene-1, octane-1, and the like in which the molecules of the copolymers comprise long chains with relatively few side chain branches or cross-linked structures. Other ethylene/alpha-olefin copolymers, such as the long chain branched homogeneous ethylene/alpha-olefin copolymers known in the art, are also included.

As used herein, the term “film” can be used in a generic sense to include plastic web, regardless of whether it is film or sheet.

As used herein, the term “polymer” refers to the product of a polymerization reaction, and can be inclusive of homopolymers, copolymers, terpolymers, etc. In some embodiments, the layers of a film can consist essentially of a single polymer, or can have additional polymer together therewith, i.e., blended therewith.

The term “polymeric film” as used herein refers to a thermoplastic material, generally in sheet or web form, having one or more layers formed from polymeric or other materials that are bonded together by any conventional or suitable method, including one or more of the following: coextrusion, extrusion coating, lamination, vapor deposition coating, and the like.

As used herein, the term “pouch” includes bags, containers, and any sealed package that can house a product, such as a medical solution.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of methods, including (but not limited to) using a heat seal technique (e.g., melt-bead sealing, thermal sealing, impulse sealing, dielectric sealing, radio frequency sealing, ultrasonic sealing, hot air, hot wire, infrared radiation).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 1-10 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the term “skin layer” refers to an outer layer of a multilayer film. Such outer film layers are subject to abuse during storage and handling of the packaged products.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide, PGA, and/or ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

All compositional percentages used herein are presented on a “by weight” basis, unless designated otherwise.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

The definitions and disclosure of the present application control over any inconsistent definitions and disclosures that may exist in an incorporated reference.

### III. The Presently Disclosed Film

III.A. Generally

The presently disclosed subject matter can be embodied in many different forms and should not be construed as limited to the embodiments set forth herein. Rather, the disclosed embodiments are provided to satisfy applicable legal requirements.

The presently disclosed subject matter is directed to polymeric films that can be used for forming flexible pouches for packaging and administering medical solutions and that have a reduced proficiency for forming bubbles in a medical solution following heat sterilization. It has been discovered that incorporating a copolyether-ester copolymer into one or more layers of the disclosed film can help prevent or reduce the formation of bubbles.

Without being bound by any particularly theory, it is believed that polymeric films include additives and other components that can migrate through the film and into the packaged solution during heat sterilization. These components can also include residuals that comprise unreacted or partially reacted monomers, dimers, and trimers. It has been discovered that the presence of a copolyether-ester copolymer in one or more layers of the pouch film can prevent or help prevent residuals and other components of the film from migrating into the pouch contents. As a result, the formation of bubbles in the packaged solution after heat sterilization can be reduced or prevented. Particularly, pouches constructed from the disclosed films are capable of passing the “bubble test” in accordance with test methods required by the Chinese State Food and Drug Administration (SFDA). The bubble test is described in the State Drug Package Container Material Standard No. YBB0112005, the content of which is hereby entirely incorporated by reference.

The disclosed film can be monolayer or multilayer. Thus, in some embodiments, the disclosed film comprises one or more layers to incorporate a variety of properties, such as sealability, gas impermeability, and toughness into a single film. Therefore, in some embodiments, the disclosed film comprises a total of from 1 to about 20 layers; in some embodiments, from 2 to about 12 layers; and in some embodiments, from 4 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film components comprise microlayering technology.

The disclosed film can have any total thickness desired, so long as the film provides the desired properties for the particular packaging operation in which the film is used, e.g., optics, modulus, seal strength, and the like. Final web thicknesses can vary, depending on processing, end use application, and the like. Typical thicknesses can range from 0.1 to 20 mils; in some embodiments, 0.3 to 15 mils; in some embodiments, 0.5 to 10 mils; and in some embodiments, 1 to 8 mils. Thus, in some embodiments, the film can have a thickness of 10 mils or less; in some embodiments, a thickness of 5 mils or less. One of ordinary skill in the art would also recognize that the presently disclosed subject matter also includes embodiments wherein films lie outside the ranges set forth herein.

III.B. Anti-Foaming Layer

As set forth herein, the disclosed film includes at least one anti-foaming layer that comprises a copolyether-ester copolymer. Copolyether-esters block copolymers suitable for use in the disclosed film comprise hard segments of alkylene terephthalate alternating with poly(alkylene oxide) soft segments. Aliphatic soft segments can include (but are not limited to) hydroxyl terminated polyethers (such as polyethylene oxide diol, polypropylene oxide diol, poly(tetramethylene oxide) diol) and polyesters end capped with ethylene oxide (such as polycaprolactone diol and polybutylene adipate diol). In some embodiments, the hard segment includes polybutylene terephthalate, polybutylene terephthalates or higher terephthalates or isophthalates of C₅-C₂₀ alkenes. The soft segment of the disclosed block copolymer comprises about 10-70 weight percent of the total weight of the copolymer, with corresponding Shore D hardness of 30 to 90 (in accordance with ASTM D2240/USI 868). The DSC melting point of the copolyester-ether copolymer can be in the range of about 140-220° C., with a vicat softening point of about 100-210° C.

Examples of suitable commercial copolyether-ester copolymers can include (but are not limited to) Hytrel® 952 (Shore D=55), Hytrel® 966 (Shore D=63), and Hytrel® 8238 (Shore D=82), all available from DuPont Elastomers (Wilmington, Del., United States of America). Further examples include Arnitel® DM460 (Shore D=40), Arnitel® EM630-H (Shore D=63), and Arnitel® EL740 (Shore D=70), all available from DSM (Heerlen, Netherlands). Still further examples include Polprene® P30B (Shore D=29), Polprene® P90B (Shore D=52), and Polprene® E450B (Shore D=78), all available from Toyobo Co. Ltd. (Osaka, Japan).

The copolyether-ester copolymer can be present in at least one anti-foaming layer in an amount of from about 10 to about 100 weight percent, based on the total weight of the layer. Thus, in some embodiments, the copolyether-ester copolymer can be present in the anti-foaming layer in an amount of at least about (or no more than) 10, 15, 20, 25, 30, 35, 40, 45, 50, 55, 60, 65, 70, 75, 80, 85, 90, 95, 99, or 99.9 weight percent, based on the total weight of the layer. In some embodiments, the copolyether-ester copolymer can be blended with any of the wide variety of polymeric materials known in the art, including (but not limited to) polyamides, polycarbonates, polyesters and/or combinations thereof. Blends of copolyether-ester of different durometers can also be present in the anti-foaming layer.

The antifoaming layer can be any layer of the disclosed film. For example, in some embodiments, an antifoaming layer can be positioned as an exterior film layer. Alternatively or in addition, in some embodiments, the antifoaming layer can be a sealant layer, a core layer, and/or any intermediate layer (i.e., layer 2, 3, 4, of a 7-layer film, for example).

III.C. Additional Film Layers

The disclosed films can comprise one or more abuse layers, barrier layers, tie layers, core layers, and/or skin layers, as would be known by those of ordinary skill in the art.

One example of a film in accordance with the presently disclosed subject matter is represented as A/B/C/D/E/F/G. “A” is an exterior film layer comprising at least one copolyether-ester copolymer. “B” is an interior layer adjacent or directly adjacent to “A” and comprises a maleic-anhydride-modified copolymer, such as maleic anhydride-modified ethylene/methyl acrylate copolymer. “C” is an interior layer directly or indirectly adjacent to “B” and “D” on either side and comprises high density polyethylene homopolymer and/or at least one ethylene/alpha-olefin, such as very low density ethylene/octene copolymer, linear low density ethylene/butene copolymer, linear low density ethylene/hexene copolymer. “D” is an interior layer positioned adjacent or directly adjacent to “C” and “E” on either side and comprises low density polyethylene homopolymer and/or at least one ethylene/alpha-olefin, such as very low density ethylene/octene copolymer or linear low density ethylene/hexene copolymer. “E” is an interior layer positioned adjacent or directly adjacent to “D” and “F” on either side and comprises at least one ethylene/alpha-olefin, such as very low density ethylene/octene copolymer, linear low density ethylene/hexene copolymer, linear low density ethylene/butene copolymer, or high density polyethylene homopolymer. “F” is an interior film layer positioned adjacent or directly adjacent to layers “E” and “G” and includes at least one ethylene/alpha-olefin, such as very low density ethylene/octene copolymer, linear low density ethylene/butene copolymer, propylene/ethylene copolymer. “G” is an inner film layer and includes at least one member selected from the group comprising styrene/ethylene/butene copolymer, linear low density ethylene/hexene copolymer, propylene/ethylene copolymer, ethylene copolymer, or polypropylene copolymer.

### IV. Methods of Making the Disclosed Film

The disclosed film can be constructed using any suitable process known in the art, including (but not limited to) coextrusion, lamination, extrusion coating, and combinations thereof. See, for example, U.S. Pat. No. 6,769,227 to Mumpower; U.S. Pat. No. 3,741,253 to Brax et al.; U.S. Pat. No. 4,278,738 to Brax et al.; U.S. Pat. No. 4,284,458 to Schirmer; and U.S. Pat. No. 4,551,380 to Schoenberg, each of which is hereby incorporated by reference in its entirety. Generally, the copolyether-ester anti-foaming components can be blended as an additive during the extrusion process, as is well known in the art, or used as a neat (100%) component layer.

The disclosed films can be formed by cast coextrusion as a tubular film, or as a flat film. Containers for medical applications or other end uses can be made directly from the coextruded, tubular film, or alternatively from rollstock material obtained from the tube after it has been slit and ply-separated. A hot blown process can also be used to make the disclosed film, although the optical properties of the resulting pouch may be inferior to those from a cast coextrusion process. Other processes, such as extrusion coating, conventional lamination, slot die extrusion, and the like can also be used to make the disclosed film, although these alternative processes can be more difficult and/or less efficient than the preferred method.

In some embodiments, the disclosed films can be cross-linked. As would be known in the art, crosslinking increases the structural strength of a film at elevated temperatures and/or increases the force at which the material can be stretched before tearing apart. In some embodiments, crosslinking can be accomplished by irradiation, i.e., bombarding the film with particulate or non-particulate radiation, such as high energy electrons from an accelerator or cobalt-60 gamma rays. In some embodiments, the irradiation dosage level is about 2-8 megarads (MR). Any conventional crosslinking technique can be used, such as curtain beam irradiation and/or chemical crosslinking (such as the use of peroxides, for example).

### V. Methods of Using the Disclosed Film

The disclosed film can be used to construct any of the wide variety of pouches known and used in the art. For example, in the formation of medical pouches, an exterior layer serves as a heat seal layer. In this manner, when a film is formed into a pouch, the exterior layer will form the inside surface of the pouch, i.e., the surface that is in contact with the packaged medical solution. The first exterior layer also forms a heat seal when the film is folded upon itself or mated with another film such that two regions of the layer are brought into contact with one another. Upon cooling, the heated segments of the exterior layer become a single, essentially inseparable layer. In this way, the heated segments of the exterior layer produce a liquid-tight heat seal. In some embodiments, the heat seals defined are generally fin-shaped and are linked together to define the peripheral boundaries of the pouch so that a medical solution can be fully enclosed therein. Examples of medical solutions that can be packaged and administered in accordance with the presently disclosed subject matter include (but are not limited to) saline solutions, dextrose solutions, solutions for dialysis applications, and the like.

In some embodiments, the disclosed pouch comprises front and rear sheets that are oriented face-to-face and affixed to each other at the side and bottom edges. Generally, each of the edges is a heat seal having a seal strength of about 40 N/in or more in accordance with ASTM F88 (incorporated herein in its entirety). However, the presently disclosed subject matter also includes embodiments wherein the edges comprise one or more frangible seal. In some embodiments, the front and rear sheets comprise two separate sheets or a single sheet of film that has been center folded at one edge. Together the sheets define a pouch with an interior compartment for receiving a solution.

In some embodiments, the disclosed pouch includes a discharge outlet adapted to be in fluid communication with the pouch interior space. In some embodiments, the discharge outlet can be connected to a standard IV device and/or administration set, as would be known to those in the art. In some embodiments, the outlet can include one or more inlets for introducing components that are to be confined within the pouch interior. Thus, the presently disclosed subject matter includes embodiments wherein the discharge outlet serves a dual role for introducing components and releasing the components of the pouch interior at a desired time. The disclosed pouch can further comprise a support, which can be an aperture, clip, etc. for attaching the pouch to a foundation (such as a stand).

The disclosed pouch can be configured in any suitable shape known and used in the art, such as (but not limited to) bottle, tray, box, and tube shapes. To this end, the shape and size of the disclosed pouch can be varied depending on its intended use and need, as would be understood by those of ordinary skill in the art.

The disclosed pouch can be prepared in any of a variety of ways. For example, in some embodiments, the pouch can be prepared from a roll of double wound multilayer film wherein the sheets are separated to form the front and rear pouch sheets. The separate sheets can then be conveyed in a substantially parallel manner. In other embodiments, the front and rear sheets can be formed from a tubular film or from sheets of film that are provided on separate supply rolls. In some embodiments, any excess sheet material can be trimmed away from around the pouch perimeter heat seals. If desired, the front and rear pouch sheets can be printed with any desired labeling information.

After the pouch has been manufactured, sealed, and filled, it can then be sterilized. Autoclaving is commonly used for sterilizing medical liquids and equipment. In some embodiments, either before or after sterilization, the pouch can be placed into a plastic overwrap or container that serve as a dust cover and help protect the pouch contents from external foreign contaminants, moisture loss, gas permeation, and the like.

The disclosed films have been described in connection with a pouch for the packaging of medical solutions. However, it is to be understood that other applications for the films are also possible and are within the scope of the presently disclosed subject matter.

### VI. Advantages of the Presently Disclosed Subject Matter

The presently disclosed pouches reduce or prevent the formation of bubbles and therefore are capable of passing the “bubble test” in accordance with the test methods required by the Chinese State Food and Drug Administration described in the State Drug Package Container Material Standard No. YBB00112005.

The disclosed film can also be produced more cheaply than comparable prior art films. In some embodiments, the disclosed film can be 20-40% less expensive to manufacture.

Although several advantages of the disclosed system are set forth in detail herein, the list is by no means limiting. Particularly, one of ordinary skill in the art would recognize that there can be several advantages to the disclosed film and methods that are not included herein.

### EXAMPLES

The following Examples provide illustrative embodiments. In light of the present disclosure and the general level of skill, those of ordinary skill in the art will appreciate that the following Examples are intended to be exemplary only and that numerous changes, modifications, and alterations can be employed without departing from the scope of the presently disclosed subject matter.

Several film structures in accordance with the presently disclosed subject matter and comparatives are identified herein below in Tables 1 and 2.

TABLE 1
Resin Identification

| Material | Trade Name or | |
|---|---|---|
| Code | Designation | Source |
| A | G1645 MO | Kraton Polymers |
| | | (Houston, Texas, United |
| | | States of America) |
| B | DS6D82 | Braskem S.A. (Sao |
| | | Paulo, Brazil) |
| C | Affinity ® EG 8100G1 | Dow Chemical Company |
| | | (Midland, Michigan, |
| | | United States of America) |
| D | LF1020AA | Westlake Chemical |
| | | Corporation (Houston, |
| | | Texas, United States of |
| | | America) |
| E | ATTANE ® 4203 | Dow Chemical Company |
| | | (Midland, Michigan, |
| | | United States of America) |
| F | MarFlex ® LF093 | Chevron Phillips |
| | | Chemical (Woodlands, |
| | | Texas, United States of |
| | | America) |
| G | EF602AA | Westlake Chemical |
| | | Corporation (Houston, |
| | | Texas, United States of |
| | | America) |
| H | 10433 | Ampacet (Tarrytown, |
| | | New York, United States |
| | | of America) |
| I | SURPASS ® HPs167-AB | Nova Chemicals (Moon |
| | | Township, Pennsylvania, |
| | | United States of America) |
| J | GT7058 | Westlake Chemical |
| | | Corporation (Houston, |
| | | Texas, United States of |
| | | America) |
| K | Ecdel ® 9965 | Eastman Chemical |
| | | Company (Kingsport, |
| | | Tennessee, United |
| | | States of America) |
| M | Hytrel ® PC952 NC010 | DuPont Dow Elastomers |
| | | (Wilmington, Delaware, |
| | | United States of America) |
| N | GT4402 | Westlake Chemical |
| | | Corporation (Houston, |
| | | Texas, United States of |
| | | America) |
| O | KRATON ® G1652 mU | Kraton Polymers |
| | | (Houston, Texas, United |
| | | States of America) |
| P | CV77528 | Westlake Chemical |
| | | Corporation (Houston, |
| | | Texas, United States of |
| | | America) |
| Q | Engage ® 8452 | Dow Chemical Company |
| | | (Midland, Michigan, |
| | | United States of America) |
| R | Millad ® Concentrate nX-10 | Milliken Chemical |
| | | (Spartanburg, South |
| | | Carolina, United States of |
| | | America) |
| T | MarFlex ® 9659 | Chevron Phillips |
| | | Chemical (Woodlands, |
| | | Texas, United States of |
| | | America) |
| U | SYLOID ® 74X6000 | Grace Davison |
| | | (Deerfield, Illinois, United |
| | | States of America) |
| V | Bormed ® SC820CF | Borealis Compounds, |
| | | Inc. (Port Murray, New |
| | | Jersey, United States of |
| | | America) |
| W | MC634 | Mitsui Petrochemical |
| | | Corporation (New York, |
| | | New York, United States |
| | | of America) |
| X | Zelas ® 7055 | Mitsui Petrochemical |
| | | Corporation (New York, |
| | | New York, United States |
| | | of America) |
| Y | IRGANOX ® 1010 | Ciba Specialty Chemicals |
| | | (Basel, Switzerland) |
| AA | CV77525 | Westlake Chemical |
| | | Corporation (Houston, |
| | | Texas, United States of |
| | | America) |
| BB | Exact ® 3128 | ExxonMobile (Fairfax, |
| | | Virginia, United States of |
| | | America) |
| CC | BYNEL ® 21E810 | E. I. DuPont de Nemours |
| | | and Company |
| | | (Wilmington, Delaware, |
| | | Untied States of America) |
| DD | Hytrel ® 966 | E. I. DuPont de Nemours |
| | | and Company |
| | | (Wilmington, Delaware, |
| | | Untied States of America) |
| EE | GT7062 | Westlake Chemical |
| | | Corporation (Houston, |
| | | Texas, United States of |
| | | America) |
| FF | Arnitel ® EM630 | DSM Engineering |
| | | Plastics (Heerlen, |
| | | Netherlands) |
| GG | Antiblock | Eastman Chemical |
| | | Company (Kingsport, |
| | | Tennessee, United |
| | | States of America) |
| HH | Bormed SC820 CF-11 | Borealis Compounds, |
| | | Inc. (Port Murray, New |
| | | Jersey, United States of |
| | | America) |

A is a styrene/ethylene/butene terpolymer.

B is propylene/ethylene copolymer.

C is very low density ethylene/octene copolymer with flow rate of 0.75-1.25 g/10 min. (E-028) and density of 0.867-0.873 g/cc (E-112).

D is linear low density ethylene/butene copolymer.

E is very low density ethylene/octene copolymer with density of 0.903-0.908 g/cc (E-112, at 23° C.), bulk density 0.53 g/cc (E-062), and DSC melting temperature of 123° C.

F is linear low density ethylene/hexene copolymer.

G is low density polyethylene homopolymer.

H is 10% amide wax in linear low density polyethylene carrier.

I is high density polyethylene homopolymer.

J is maleic anhydride-modified ethylene/methyl acrylate copolymer.

K is copolyester with DSC melting point of 195-215° C. and density of 1.13 g/cc (E-112).

L is a slip masterbatch containing 20% PDMS in polyamide 6.

M is polyester block copolyether-ester.

N is maleic anhydride-modified polyethylene with melt index of 1.9-2.9.

O is styrene/ethylene/butene copolymer with specific gravity of 0.91, styrene:rubber ratio of 27:71, and solution viscosity of 350-600 centipose (20 wt % solution in toluene at 25° C.).

P is linear low density ethylene/hexene copolymer with melt index of 1.7-2.3 degrees/minute (E-028) and density of 0.908-0.912 g/cc (E-112).

Q is very low density ethylene/octene copolymer.

R is clarifier in polypropylene.

T is high density ethylene/butene copolymer.

U is antiblock with density of 2.1 g/cc (E-112).

V is propylene/ethylene copolymer with flow rate of 6.0-9.0 g/10 min (E-028) and density of 0.895-0.905 g/cc (E-112).

W is ethylene copolymer.

X is polypropylene copolymer.

Y is phenolic antioxidant.

AA is a Ziegler/Nana catalyzed ethylene/1-hexene copolymer with a density of 0.906 grams/cc.

BB is an ethylene/alpha-olefin copolymer with a melt index approximately 1.2 and a density about 0.900.

CC is an anhydride-modified ethylene/methyl acrylate copolymer having a melt index of about 2.8 dg/min (ASTM D-1238) and a density of about 0.931 g/cc (ASTM-1505).

DD is thermoplastic polyester elastomer with density of 1220 kg/m³ (ISO 1183).

EE is maleic anhydride-modified ethylene/methyl acrylate copolymer.

FF is polybutylene terephthalate/glycol block copolymer.

GG is antiblock.

HH is a heterophase polypropylene random copolymer.

TABLE 2
Film Identification

| Film ID | Layer | Formulation | | Volume % | Mils |
|---|---|---|---|---|---|
| Film 1 | 1 | 80% | B | 11.67 | 0.70 |
| Control | | 20% | A | | |
| | 2 | 75% | C | 6.67 | 0.40 |
| | | 25% | D | | |
| | 3 | 70% | E | 28.33 | 1.70 |
| | | 20% | F | | |
| | | 10% | D | | |
| | 4 | 70% | E | 25.0 | 1.50 |
| | | 20% | F | | |
| | | 10% | G | | |
| | 5 | 90% | I | 18.33 | 1.10 |
| | | 10% | D | | |
| | 6 | 100% | J | 5.0 | 0.30 |
| | 7 | 100% | K | 5.0 | 0.30 |
| Film 2 | 1 | 80% | B | 11.67 | 0.70 |
| | | 20% | A | | |
| | 2 | 75% | C | 6.67 | 0.40 |
| | | 25% | D | | |
| | 3 | 70% | E | 28.33 | 1.70 |
| | | 20% | F | | |
| | | 10% | D | | |
| | 4 | 70% | E | 25.0 | 1.50 |
| | | 16% | F | | |
| | | 10% | G | | |
| | | 4% | H | | |
| | 5 | 90% | I | 18.33 | 1.10 |
| | | 10% | D | | |
| | 6 | 100% | J | 5.0 | 0.30 |
| | 7 | 96% | K | 5.0 | 0.30 |
| | | 4% | L | | |
| Film 3 | 1 | 80% | B | 11.67 | 0.70 |
| | | 20% | A | | |
| | 2 | 75% | C | 6.67 | 0.40 |
| | | 25% | D | | |
| | 3 | 70% | E | 25.83 | 1.55 |
| | | 20% | F | | |
| | | 10% | D | | |
| | 4 | 70% | E | 22.50 | 1.35 |
| | | 20% | F | | |
| | | 10% | G | | |
| | 5 | 70% | I | 18.33 | 1.10 |
| | | 30% | D | | |
| | 6 | 100% | J | 10.0 | 0.60 |
| | 7 | 100% | M | 5.0 | 0.30 |
| Film 4 | 1 | 80% | B | 11.67 | 0.70 |
| | | 20% | A | | |
| | 2 | 75% | C | 6.67 | 0.40 |
| | | 25% | D | | |
| | 3 | 70% | E | 25.83 | 1.55 |
| | | 20% | F | | |
| | | 10% | D | | |
| | 4 | 70% | E | 22.50 | 1.35 |
| | | 20% | F | | |
| | | 10% | G | | |
| | 5 | 55% | I | 18.33 | 1.10 |
| | | 45% | D | | |
| | 6 | 100% | J | 10.0 | 0.60 |
| | 7 | 100% | M | 5.0 | 0.30 |
| Film 5 | 1 | 80% | B | 11.67 | 0.70 |
| | | 20% | A | | |
| | 2 | 75% | C | 6.67 | 0.40 |
| | | 25% | D | | |
| | 3 | 70% | E | 25.83 | 1.55 |
| | | 20% | F | | |
| | | 10% | D | | |
| | 4 | 70% | E | 22.50 | 1.35 |
| | | 20% | F | | |
| | | 10% | G | | |
| | 5 | 55% | I | 18.33 | 1.10 |
| | | 45% | D | | |
| | 6 | 100% | J | 10.0 | 0.60 |
| | 7 | 100% | M | 5.0 | 0.30 |
| Film 6 | 1 | 75% | B | 11.67 | 0.70 |
| | | 25% | A | | |
| | 2 | 75% | C | 6.67 | 0.40 |
| | | 25% | D | | |
| | 3 | 70% | E | 25.83 | 1.55 |
| | | 20% | F | | |
| | | 10% | D | | |
| | 4 | 70% | E | 22.50 | 1.35 |
| | | 20% | F | | |
| | | 10% | G | | |
| | 5 | 55% | I | 18.33 | 1.10 |
| | | 25% | F | | |
| | | 20% | E | | |
| | 6 | 100% | J | 10.0 | 0.60 |
| | 7 | 100% | M | 5.0 | 0.30 |
| Film 7 | 1 | 80% | B | 11.67 | 0.70 |
| | | 20% | A | | |
| | 2 | 75% | C | 6.67 | 0.40 |
| | | 25% | D | | |
| | 3 | 56% | E | 25.83 | 1.55 |
| | | 20% | I | | |
| | | 16% | F | | |
| | | 8% | D | | |
| | 4 | 70% | E | 22.50 | 1.35 |
| | | 20% | F | | |
| | | 10% | G | | |
| | 5 | 56% | E | 18.33 | 1.10 |
| | | 20% | I | | |
| | | 16% | F | | |
| | | 8% | D | | |
| | 6 | 100% | J | 10.0 | 0.60 |
| | 7 | 100% | M | 5.0 | 0.30 |
| Film 8 | 1 | 80% | B | 11.67 | 0.70 |
| | | 20% | A | | |
| | 2 | 75% | C | 6.67 | 0.40 |
| | | 25% | D | | |
| | 3 | 56% | E | 28.33 | 1.70 |
| | | 20% | I | | |
| | | 16% | F | | |
| | | 8% | D | | |
| | 4 | 70% | E | 25.0 | 1.50 |
| | | 20% | F | | |
| | | 10% | G | | |
| | 5 | 56% | E | 18.33 | 1.10 |
| | | 20% | I | | |
| | | 16% | F | | |
| | | 8% | D | | |
| | 6 | 100% | N | 5.0 | 0.30 |
| | 7 | 100% | M | 5.0 | 0.30 |
| Film 9 | 1 | 60% | B | 16.22 | 1.25 |
| Control | | 20% | O | | |
| | | 20% | P | | |
| | 2 | 50% | B | 5.19 | 0.40 |
| | | 50% | E | | |
| | 3 | 64% | E | 19.43 | 1.50 |
| | | 30% | Q | | |
| | | 6% | R | | |
| | 4 | 55% | E | 44.70 | 2.65 |
| | | 20% | Q | | |
| | | 15% | T | | |
| | | 10% | G | | |
| | 5 | 55% | E | 11.0 | 0.80 |
| | | 20% | Q | | |
| | | 15% | T | | |
| | | 10% | G | | |
| | 6 | 100% | J | 5.45 | 0.40 |
| | 7 | 95% | K | 9.01 | 0.50 |
| | | 5% | U | | |
| Film 10 | 1 | 60% | B | 16.12 | 1.25 |
| | | 20% | O | | |
| | | 20% | P | | |
| | 2 | 50% | B | 5.19 | 0.40 |
| | | 50% | E | | |
| | 3 | 70% | E | 34.75 | 2.65 |
| | | 30% | F | | |
| | 4 | 70% | E | 19.34 | 1.50 |
| | | 20% | F | | |
| | | 10% | G | | |
| | 5 | 55% | I | 11.0 | 0.80 |
| | | 25% | F | | |
| | | 20% | E | | |
| | 6 | 100% | J | 5.44 | 0.40 |
| | 7 | 100% | M | 8.16 | 0.50 |
| Film 11 | 1 | 70% | B | 16.12 | 1.25 |
| | | 20% | O | | |
| | | 10% | P | | |
| | 2 | 50% | B | 5.19 | 0.40 |
| | | 50% | E | | |
| | 3 | 70% | E | 34.75 | 2.65 |
| | | 30% | F | | |
| | 4 | 70% | E | 19.34 | 1.50 |
| | | 20% | F | | |
| | | 10% | G | | |
| | 5 | 55% | I | 11.0 | 0.80 |
| | | 25% | F | | |
| | | 20% | E | | |
| | 6 | 100% | J | 5.44 | 0.40 |
| | 7 | 100% | M | 8.16 | 0.50 |
| Film 12 | 1 | 70% | V | 16.12 | 1.25 |
| | | 15% | A | | |
| | | 15% | P | | |
| | 2 | 50% | B | 5.19 | 0.40 |
| | | 50% | E | | |
| | 3 | 70% | E | 34.75 | 2.65 |
| | | 30% | F | | |
| | 4 | 70% | E | 19.34 | 1.50 |
| | | 20% | F | | |
| | | 10% | G | | |
| | 5 | 55% | I | 11.0 | 0.80 |
| | | 25% | F | | |
| | | 20% | E | | |
| | 6 | 100% | J | 5.44 | 0.40 |
| | 7 | 100% | M | 8.16 | 0.50 |
| Film 13 | 1 | 70% | V | 16.12 | 1.25 |
| | | 15% | A | | |
| | | 15% | P | | |
| | 2 | 50% | B | 5.19 | 0.40 |
| | | 50% | E | | |
| | 3 | 59.5% | E | 34.75 | 2.65 |
| | | 25.5% | F | | |
| | | 15% | I | | |
| | 4 | 70% | E | 19.34 | 1.50 |
| | | 20% | F | | |
| | | 10% | G | | |
| | 5 | 59.5% | E | 11.0 | 0.80 |
| | | 25.5% | F | | |
| | | 15% | I | | |
| | 6 | 100% | J | 5.44 | 0.40 |
| | 7 | 100% | M | 8.16 | 0.50 |
| Film 14 | 1 | 60% | X | 16.12 | 1.25 |
| | | 40% | W | | |
| | 2 | 50% | B | 5.19 | 0.40 |
| | | 50% | E | | |
| | 3 | 70% | E | 34.75 | 2.65 |
| | | 30% | F | | |
| | 4 | 70% | E | 19.34 | 1.50 |
| | | 20% | F | | |
| | | 10% | G | | |
| | 5 | 55% | I | 11.0 | 0.80 |
| | | 25% | F | | |
| | | 20% | E | | |
| | 6 | 100% | J | 5.44 | 0.40 |
| | 7 | 100% | M | 8.16 | 0.50 |
| Film 15 | 1 | 80% | B | 11.20 | 0.70 |
| | | 20% | A | | |
| | 2 | 75% | BB | 6.40 | 0.40 |
| | | 25% | D | | |
| | 3 | 63% | AA | 23.20 | 1.45 |
| | | 21% | I | | |
| | | 16% | F | | |
| | 4 | 54% | AA | 20.80 | 1.30 |
| | | 21% | I | | |
| | | 15% | F | | |
| | | 10% | G | | |
| | 5 | 63% | AA | 23.20 | 1.45 |
| | | 21% | I | | |
| | | 16% | F | | |
| | 6 | 100% | CC | 8.80 | 0.55 |
| | 7 | 45% | DD | 6.40 | 0.40 |
| | | 56% | FF | | |
| | | 7% | K | | |
| | | 3% | GG | | |
| Film 16 | 1 | 80% | B | 11.20 | 0.70 |
| | | 20% | A | | |
| | 2 | 70% | Z | 6.40 | 0.40 |
| | | 30% | AA | | |
| | 3 | 63% | AA | 23.20 | 1.45 |
| | | 21% | I | | |
| | | 16% | F | | |
| | 4 | 54% | AA | 22.40 | 1.40 |
| | | 21% | I | | |
| | | 15% | F | | |
| | | 10% | G | | |
| | 5 | 63% | AA | 23.20 | 1.45 |
| | | 21% | I | | |
| | | 16% | F | | |
| | 6 | 100% | EE | 8.00 | 0.50 |
| | 7 | 45% | DD | 5.60 | 0.35 |
| | | 45% | FF | | |
| | | 7% | K | | |
| | | 3% | GG | | |
| Film 17 | 1 | 80% | HH | 16.67 | 1.25 |
| | | 20% | O | | |
| | 2 | 50% | B | 5.33 | 0.40 |
| | | 50% | AA | | |
| | 3 | 70% | AA | 24.00 | 1.80 |
| | | 20% | F | | |
| | | 10% | I | | |
| | 4 | 70% | AA | 14.67 | 1.10 |
| | | 20% | F | | |
| | | 10% | G | | |
| | 5 | 70% | AA | 23.33 | 1.75 |
| | | 20% | F | | |
| | | 10% | I | | |
| | 6 | 100% | EE | 9.33 | 0.70 |
| | 7 | 70% | DD | 6.67 | 0.50 |
| | | 20% | FF | | |
| | | 8% | K | | |
| | | 2% | GG | | |
| Film 18 | 1 | 80% | HH | 16.67 | 1.25 |
| | | 20% | O | | |
| | 2 | 50% | HH | 5.33 | 0.40 |
| | | 50% | C | | |
| | 3 | 70% | AA | 24.00 | 1.80 |
| | | 20% | F | | |
| | | 10% | I | | |
| | 4 | 70% | AA | 14.67 | 1.10 |
| | | 20% | F | | |
| | | 10% | G | | |
| | 5 | 70% | AA | 23.33 | 1.75 |
| | | 20% | F | | |
| | | 10% | I | | |
| | 6 | 100% | EE | 9.33 | 0.70 |
| | 7 | 70% | DD | 6.67 | 0.50 |
| | | 20% | FF | | |
| | | 8% | K | | |
| | | 2% | GG | | |
| Film 19 | 1 | 80% | B | 11.67 | 0.70 |
| | | 20% | A | | |
| | 2 | 75% | BB | 6.67 | 0.40 |
| | | 25% | D | | |
| | 3 | 63% | AA | 24.17 | 1.45 |
| | | 21% | I | | |
| | | 16% | F | | |
| | 4 | 54% | AA | 20.0 | 1.20 |
| | | 21% | I | | |
| | | 15% | F | | |
| | | 10% | G | | |
| | 5 | 63% | AA | 24.17 | 1.45 |
| | | 21% | I | | |
| | | 16% | F | | |
| | 6 | 100% | EE | 8.33 | 0.50 |
| | 7 | 45% | DD | 5.0 | 0.30 |
| | | 45% | FF | | |
| | | 8% | K | | |
| | | 2% | GG | | |
| Film 20 | 1 | 80% | B | 11.67 | 0.70 |
| | | 20% | A | | |
| | 2 | 50% | C | 6.67 | 0.40 |
| | | 50% | B | | |
| | 3 | 63% | AA | 24.17 | 1.45 |
| | | 21% | I | | |
| | | 16% | F | | |
| | 4 | 54% | AA | 20.0 | 1.20 |
| | | 21% | I | | |
| | | 15% | F | | |
| | | 10% | G | | |
| | 5 | 63% | AA | 24.17 | 1.45 |
| | | 21% | I | | |
| | | 16% | F | | |
| | 6 | 100% | EE | 8.33 | 0.50 |
| | 7 | 45% | DD | 5.0 | 0.30 |
| | | 45% | FF | | |
| | | 8% | K | | |
| | | 2% | GG | | |
| Film 21 | 1 | 80% | B | 11.67 | 0.70 |
| | | 20% | A | | |
| | 2 | 50% | C | 6.67 | 0.40 |
| | | 50% | B | | |
| | 3 | 55% | AA | 24.17 | 1.45 |
| | | 30% | I | | |
| | | 15% | F | | |
| | 4 | 70% | AA | 20.0 | 1.20 |
| | | 20% | F | | |
| | | 10% | G | | |
| | 5 | 55% | AA | 24.17 | 1.45 |
| | | 30% | I | | |
| | | 15% | F | | |
| | 6 | 100% | EE | 8.33 | 0.50 |
| | 7 | 45% | DD | 5.0 | 0.30 |
| | | 45% | FF | | |
| | | 8% | K | | |
| | | 2% | GG | | |

### Example 1

### Preparation of Films 1-21

Films 1-21 were manufactured by cast coextrusion. This method is well known to those of ordinary skill in the art.

### Example 2

### Elution Bubble Testing of Films 1-14 and 17-21

Films 1-14 and 17-21 were subjected to the Elution Bubble Test introduced in SFDA Standard YBB0112005 as a pass/fail criterion required for medical film and bags used to package infusion products.

For each film, a 600 cm² inner section was cut into 5 cm×0.5 cm slices. The slices were washed with water and dried at room temperature. The slices were then put in a 500 mL taper bottle containing 200 mL of water. The bottle was sealed and placed into a high-pressure steam sterilizer for 30 minutes at a temperature of 121° C. The bottle was then cooled to room temperature. 5 mL of the sterilized water was removed from the bottle and put into a standard test tube (inner diameter of 15 mm and height of 200 mm) with a stopper. The test tube was vigorously shaken for 3 minutes, followed by a 3 minute rest period. The experiment was repeated 16 times for each film tested.

Test tubes given a “pass” rating had no bubbles at the end of the rest period. Test tubes given a “fail” rating had one or more bubbles remaining after the rest period. The elution bubble test results are shown below in Table 3.

TABLE 3
Elution Bubble Test Results for Films 1-14 and 17-21

| Film No. | % Pass |
|---|---|
| 1 Control | 0 |
| 2 | 81.25 |
| 3 | 100 |
| 4 | 100 |
| 5 | 100 |
| 6 | 100 |
| 7 | 100 |
| 8 | 100 |
| 9 Control | 31.25 |
| 10 | 100 |
| 11 | 100 |
| 12 | 100 |
| 13 | 100 |
| 14 | 100 |
| 17 | 100 |
| 18 | 100 |
| 19 | 100 |
| 20 | 100 |
| 21 | 100 |

### Conclusions from Example 2

The results from Example 2 (specifically, Films 3-8, 10-14, and 17-21) indicate that the use of a copolyether-ester copolymer in a multilayer structure renders the film able to pass the bubble test (i.e., Chinese State Drug Package Container Material Std. No. YBB0112005).

What is claimed is:

1. A polymeric film comprising at least one antifoaming layer, wherein the antifoaming layer comprises:
a. about 10 to 100 weight percent copolyether-ester copolymer, based on the total weight of the layer, and
b. about 0 to 90 weight percent polyamide, polyester, polyolefin, or combinations thereof, based on the total weight of the layer.

2. The film of claim 1, wherein the copolyether-ester copolymer comprises alkylene terephthalate alternating with poly(alkylene oxide).

3. The film of claim 1, wherein said film is a monolayer film.

4. The film of claim 1, wherein the film is a multilayer film and said antifoaming layer is an outer film layer.

5. The film of claim 1, wherein the film is a multilayer film and said antifoaming layer is positioned adjacent or directly adjacent to an outer film layer.

6. The film of claim 1, wherein the film is capable of passing the bubble test as set forth in the Chinese State Drug Package Container Material Standard No. YBB0112005.

7. A pouch formed from the film of claim 1, wherein the pouch includes front and back sheets oriented in a face-to-face relationship and sealed to each other along adjacent side edges to define an interior compartment therebetween.

8. The pouch of claim 7, wherein the copolyether-ester copolymer comprises alkylene terephthalate alternating with poly(alkylene oxide).

9. The pouch of claim 7, wherein the film is capable of passing the bubble test as set forth in the Chinese State Drug Package Container Material Standard No. YBB0112005.

10. The pouch of claim 7, further comprising a solution contained within the interior pouch compartment.

11. The pouch of claim 10, wherein the solution is selected from the group comprising: water, saline solution, buffer solution, Ringer solution, dextrose solution, Hank solution, glucose solution, and combinations thereof.

12. A method of reducing or preventing the formation of bubbles in a solution contained within a pouch after heat sterilization, the method comprising:
a. extruding the film of claim 1;
b. forming the film into a pouch having an interior space for receiving a medical solution, wherein upon packaging a medical solution therein, the pouch is capable of passing the bubble test as set forth in the Chinese State Drug Package Container Material Standard No. YBB0112005.

13. The method of claim 12, wherein the copolyether-ester copolymer comprises alkylene terephthalate alternating with poly(alkylene oxide).

14. The method of claim 12, further comprising the step of introducing a medical solution into the pouch through an opening therein and sealing said opening closed.

15. The method of claim 12, wherein the solution is selected from the group comprising: water, saline solution, buffer solution, Ringer solution, dextrose solution, Hank solution, glucose solution, and combinations thereof.
